(19) United States
(12) Patent Application Publication
(10) Pub. No.: US 2012/0090283 A1
(43) Pub. Date: Apr. 19, 2012

(54) APPARATUS FOR WELDING AND SEPARATING PACKAGING MATERIALS

(75) Inventors: Juergen Ippers, Grefrath (DE); Ulrich Wieduwilt, Schwaebisch Gmuend (DE); Claudia Broos, Schwaikheim (DE)

(73) Assignee: ROBERT BOSCH GMBH, Stuttgart (DE)

(21) Appl. No.: 13/262,810

(22) PCT Filed: Feb. 26, 2010
(86) PCT No.: PCT/EP2010/052475

§ 371 Date: Dec. 12, 2011

(30) Foreign Application Priority Data
Apr. 1, 2009 (DE) 10 2009 002 093.4

(51) Int. Cl. B65B 51/22; B65B 51/30; B29C 65/74

(52) U.S. Cl. 53/548; 156/379.6

(57) ABSTRACT

The invention relates to an apparatus for welding and separating a packaging material (8), comprising an ultrasonic welding apparatus (2) having a sonotrode (3) with at least one sonotrode segment (3a), and an anvil (4) with at least one anvil segment (4a), and a combined cutting and tensioning device (5), wherein the sonotrode (3) can be rotated about a first rotational axis, and wherein the anvil (4) can be rotated about a second rotational axis. The cutting and tensioning device (5) is integrated in the ultrasonic welding apparatus (2), wherein initially, the cutting and tensioning device (5) tensions the fed packaging material (8), cutting it thereafter in a tensioned state with a blade (6).

### BACKGROUND OF THE INVENTION

The present invention relates to an apparatus for welding and separating packaging materials with a combined cutting and tensioning device, which is used, in particular, in bag forming, filling and sealing machines.

Bag forming, filling and sealing machines that package, for example, sweets or other articles are known in the prior art. In this case, an oblong closed sleeve is normally produced from a film over a moulding shoulder and then the open end of the sleeve is sealed by way of a cross sealing operation. The sleeve is then filled and sealed again above the filling region by means of a further cross sealing process. In this case, at the same time as the second cross sealing process is performed at the foot end of a tubular bag, a first side of a following bag (head end) is also sealed. A cutting apparatus is usually provided then in order to separate the bags that are still joined together. In this case, it is known to carry out the welding operation, for example, by means of ultrasound, the ultrasonic welding apparatus including a sonotrode and an anvil. The packaging material is welded between the sonotrode and the anvil by the two parts making contact.

### SUMMARY OF THE INVENTION

The apparatus according to the invention has, in contrast, the advantage that it makes it possible to weld and separate packaging material, in particular tubular bags, in one operating step. Provided according to the invention for this purpose is an ultrasonic welding apparatus having a sonotrode with at least one sonotrode segment, and an anvil with at least one anvil segment. In this case, the sonotrode and the anvil are in each case arranged so as to be rotatable about an axis of rotation. In addition, a combined cutting and tensioning device is provided which initially tensions a supplied packaging material and then cuts it. The combined cutting and tensioning device, in this case, is a one-piece tool that can carry out the two functions of “tensioning and cutting” and is incorporated in the ultrasonic welding apparatus. The cutting and tensioning device includes a cutting edge which preferably carries out a tensioning operation as well as a cutting operation.

The cutting and tensioning device is preferably located on the anvil. This means that a particularly compact and simple setup can be achieved.

In addition, the sonotrode preferably includes a plurality of radially outwardly projecting sonotrode segments and the anvil includes a plurality of radially outwardly projecting anvil segments. Consequently, the sonotrode and the anvil are each realized in a star-shaped manner and a rotational sealing system can be provided which ensures a high sealing output per unit time.

In order to enable as rapid an adaptation as possible to different packaging requirements, the combined cutting and tensioning device also includes an adjusting device in order to adjust the cutting and tensioning device in the radial direction. This means that, in particular, a position of an edge of cut between two consecutive packagings is able to be changed in a simple manner.

According to a further preferred development of the invention, a recess is formed on the sonotrode segment, said recess being arranged in such a manner that it accommodates the combined cutting and tensioning device at least partially for the cutting operation without there being any contact, in this case, between the cutting and tensioning device and the walls of the recess or of the sonotrode. This ensures that a packaging material is cut without the cutting tool contacting another component.

This means that there can be no wear on the combined cutting and tensioning device. This also means that vibration decoupling, in particular, can be dispensed with such that the apparatus according to the invention is very cost-efficient. The recess, in this case, is preferably rectangular or triangular or trapezoidal or circular.

In a particularly preferred manner, the adjusting device includes two slanting planes, which are arranged in line with each other, and by means of a relative displacement on the two planes, the corresponding change in height can be made.

In order to be able to carry out different types of cuts, the combined cutting and tensioning device is preferably arranged on the anvil so as to be exchangeable. A cutting edge of the cutting and tensioning device, in this case, is selected in an arbitrary manner and is provided, in particular, straight or undulating or in a zigzag arrangement.

In a further preferred manner, a first and a second sealing region is realized in each case on the sonotrode segment and on the anvil segment and the cutting and tensioning device is arranged between the first and the second sealing region. The result here is that through the rotational arrangement of sonotrode and anvil, first of all a sealing step (foot seam of the leading packaging), then the tensioning and cutting step and then again a sealing step (head seam of the following packaging) are carried out.

The apparatus according to the invention, in this case, can be arranged horizontally or vertically, i.e. a conveying direction for the packaging material can be horizontal or vertical. In addition, the apparatus can operate continuously or intermittently.

In addition, the invention relates to a bag forming, filling and sealing machine, which comprises an apparatus according to the invention for welding and separating packaging materials. In a particularly preferred manner, in this case, the sonotrode and the anvil are arranged vertically and the conveying direction of the created tubular bags is also vertical. This means that it is also possible for the packaging material to be entrained through contact between the sonotrode and the anvil during the sealing steps.

It must be noted that, in principle, the number of sonotrode segments and the number of anvil segments is freely selectable and, where applicable, is dependent on the product size or on a diameter of the rotating sonotrode or of the rotating anvil. However, an even number of sonotrode segments and anvil segments is preferred and 2 to 8 segments are particularly preferred, preferably in each case 6 segments.

### BRIEF DESCRIPTION OF THE DRAWINGS

Exemplary embodiments of the invention are described below with reference to the accompanying drawing, in which, in detail:

FIG. 1 shows a schematic view of an apparatus according to a first exemplary embodiment of the invention, in a first position,

FIG. 2 shows a schematic view of the apparatus in FIG. 1, in a second position,

FIG. 3 shows a schematic view of the apparatus in FIG. 1, in a third position,

FIG. 4 shows a schematic view of the apparatus in FIG. 1, in a fourth position,

FIG. 5 shows a schematic view of the apparatus in FIG. 1, in a fifth position,

FIG. 6 shows a schematic side view of a cutting and tensioning device according to the first exemplary embodiment,

FIG. 7 shows a schematic view of the apparatus according to a second exemplary embodiment,

FIG. 8 shows a schematic view of the apparatus according to a third exemplary embodiment of the invention.

### DETAILED DESCRIPTION

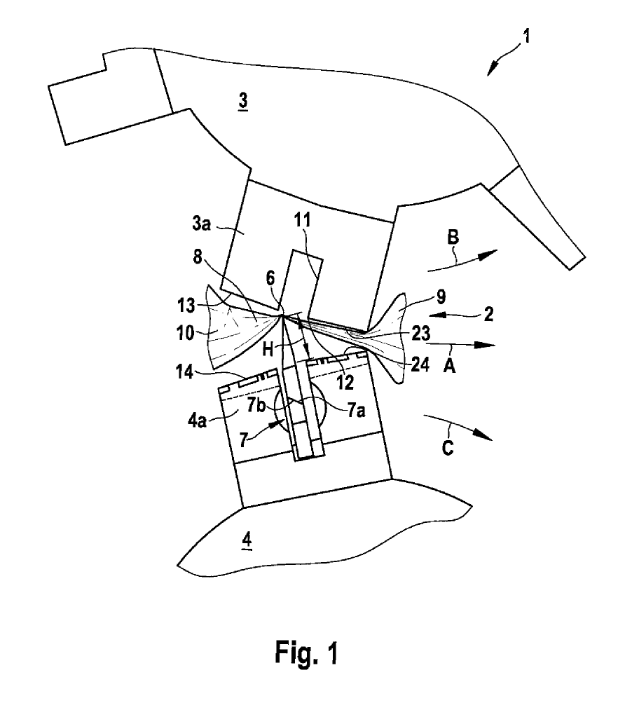

An apparatus 1 for welding and separating packaging materials according to a preferred exemplary embodiment of the invention is described below in detail with reference to FIGS. 1 to 6.

As can be seen from FIGS. 1 to 6, the apparatus 1 for welding and separating packaging materials includes an ultrasonic welding apparatus 2 having a sonotrode 3 and an anvil 4. The sonotrode 3 and the anvil 4 are in each case constructed in a star-shaped manner, the sonotrode 3 including a plurality of sonotrode segments 3a that protrude radially outwardly from a central region. The anvil 4 is also constructed in a star-shaped manner and includes a plurality of anvil segments 4a that also protrude outwardly in a star-shaped manner from a central region of the anvil. The number of sonotrode segments 3a and of anvil segments 4a, in this case, is identical and is, for example, 6. The sonotrode 3 is rotatable about an axis of rotation (not shown) in the direction of arrow B and the anvil 4 is rotatable about an axis of rotation (not shown either) in the direction of arrow C.

In this exemplary embodiment, the sonotrode and the anvil 4 are arranged vertically and the packaging material 8 is guided through between the sonotrode 3 and the anvil 4 in the direction of arrow A.

In this exemplary embodiment, the apparatus 1 is part of a bag forming, filling and sealing machine which operates in a continuous or intermittent manner and, in this case, forms and fills bags. The reference 9, in this case, is given to a bag that has already been filled with an article, such as, for example, sweets, and the reference 10 denotes a bag that has already been formed, but has not yet been filled.

The sonotrode 3 has a first sealing region 13 and a second sealing region 23 on each sonotrode segment 3a. In an identical manner, each anvil segment 4a of the anvil 4 has a first sealing region 14 and a second sealing region 24. As is clear from FIGS. 1 to 5, in this case the first sealing regions 13, 14 and the second sealing regions 23, 24 interact in each case in order to carry out a sealing operation in dependence on a position of rotation between the sonotrode 3 and the anvil 4. As can be seen from FIG. 3 or FIG. 5, the second sealing regions 23, 24 serve for sealing a foot seam of a leading bag 9 that has already been filled and the first sealing regions 13, 14 serve for sealing a head seam of a trailing bag 10 (FIG. 5).

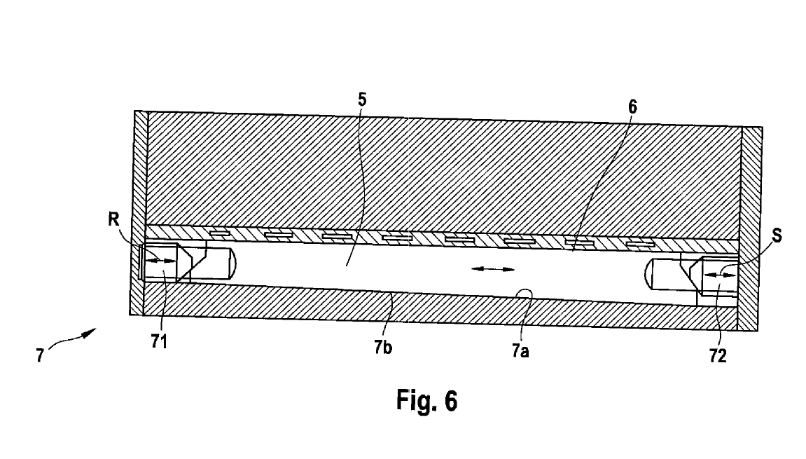

In addition, the apparatus 1 includes a combined cutting and tensioning device 5. The combined cutting and tensioning device 5 is used, on the one hand, for tensioning the packaging material 8 and, on the other hand, for cutting the packaging material in order to separate the leading bag 9 from the trailing bag 10. As can be seen from the figures, the cutting and tensioning device 5 is arranged on the anvil 4, more precisely on each anvil segment 4a. The cutting and tensioning device 5, in this case, is arranged on the anvil between the first sealing region 14 and the second sealing region 24 of the anvil segment. In this case, the cutting and tensioning device 5 protrudes at a height H radially above the anvil segment 4a. The cutting and tensioning device 5 includes a height adjusting device 7 in order to adjust a relative position of the cutting and tensioning device 5 in relation to the anvil segment 4a. To this end, the height adjusting device 7 includes a first slanting plane 7a and a second slanting plane 7b. By changing the position on the slanting planes, the height of the cutting and tensioning device 5 can be changed. As can be seen in FIG. 6, the height adjusting device 7 includes a first screw 71 and a second screw 72. Said two screws 71, 72, as indicated by the two double arrows R and S, can be adjusted in both directions in the longitudinal direction of the cutting edge 6. This means that it is possible for the entire cutting and tensioning device 5 to be adjusted to the side, a height adjustment of the cutting and tensioning device 5 upwards or downwards being possible on account of the slanting planes 7a, 7b. As the slanting planes 7a, 7b have only a very small gradient, it is possible to carry out a very precise height adjustment.

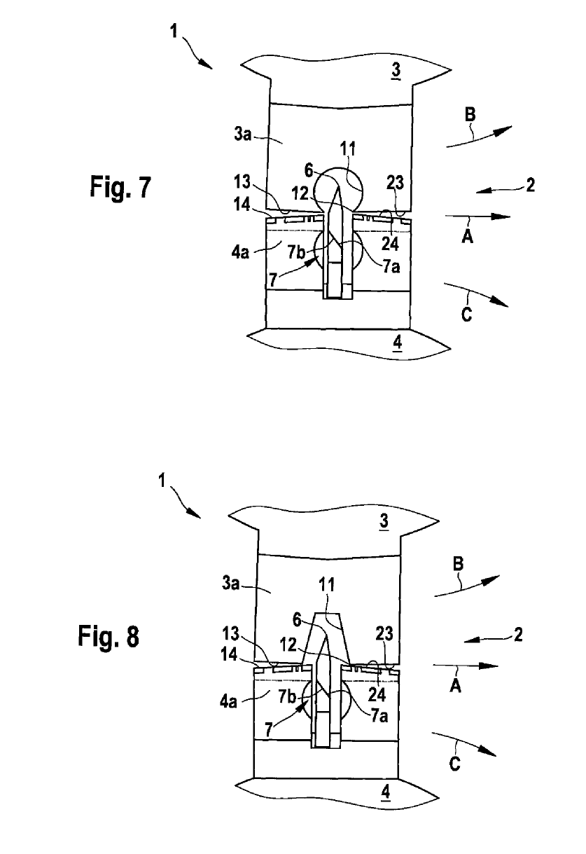

In addition, a recess 11 is provided in the sonotrode segment 3a. The recess 11 is arranged at a similar position on the sonotrode segment 3a as the cutting and tensioning device 5 on the anvil, i.e. between the first sealing region 13 and the second sealing region 23. The recess 11, in this case, is developed in such a manner that contact between the cutting and tensioning device 5 and the sonotrode 3 during the operation is avoided. In this exemplary embodiment, the recess 11 is rectangular. However, it can be circular, as shown in FIG. 6, or trapezoidal, as shown in FIG. 7. In this case, the recess 11 forms with, in each case, an outer circumferential region of the sonotrode segment 3a an edge 12 that supports a tensioning operation of the packaging material 8.

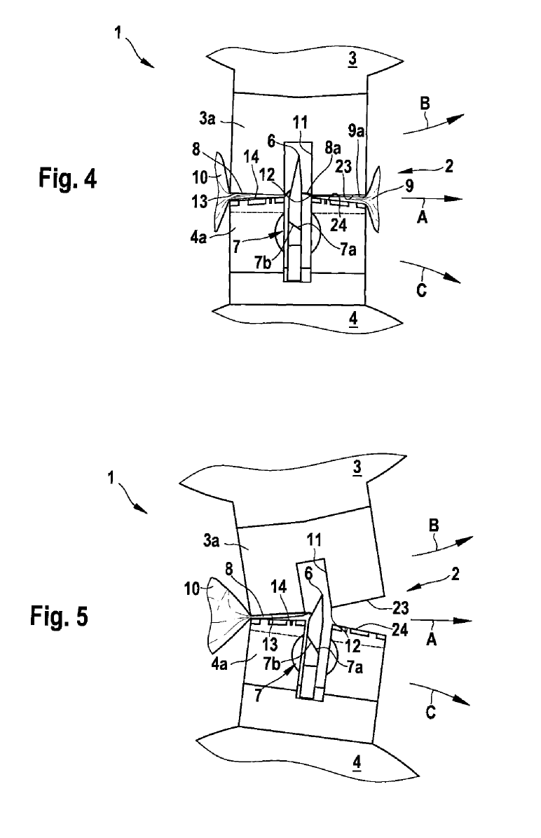

As can be seen in particular from FIG. 4, the cutting and tensioning device 5 extends partially into the recess 11 during the sealing operation without there being at the same time, however, any contact between the cutting and tensioning device 5 and the sonotrode segment 3a. This means that a cutting edge 6 that is arranged at the radial end of the cutting and tensioning device 5 is protected from contact with the sonotrode segment 3a which means that no wear occurs on the cutting edge 6 due to contact.

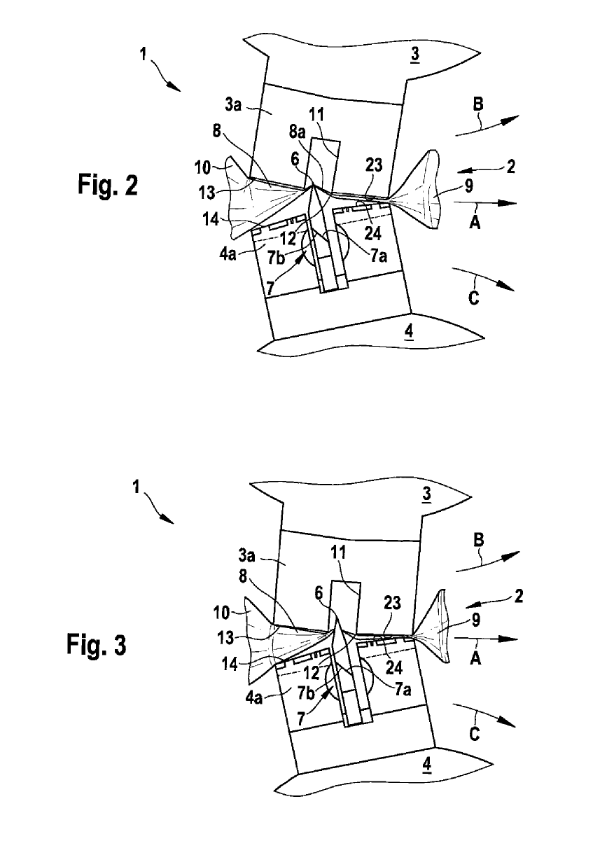

The functioning of the apparatus 1 according to the invention, in this case, is as follows. As can be seen in FIG. 1, in a first step, the cutting edge 6 comes into contact with the packaging material 8 between the leading bag 9 and the trailing bag 10. However, in this case, this is not yet a cutting operation as the packaging material 8 is not yet correctly tensioned. When the sonotrode 3 and the anvil 4 rotate further in the direction of arrows B and C, the cutting edge 6 of the cutting and tensioning device 5 migrates somewhat into the recess 11. In this case, as can be seen in FIG. 2, the packaging material is tensioned at a region 8a substantially between the cutting edge 6 and the edge 12 on the sonotrode segment 3a. This causes the cutting edge 6 to begin to penetrate into the packaging material 8 and carry out the cutting operation (FIG. 3). Consequently, the cutting edge 6 has, at the same time, a tensioning and cutting function. At the same time, with the position shown in FIG. 3, the sealing operation of the foot seam of the leading bag 9 by the second sealing regions 23, 24 begins between sonotrode and anvil. In the position shown in FIG. 4, the cutting operation is completed such that the leading bag 9, which has already been filled, is separated from the trailing bag 10. Likewise in FIG. 4, the sealing operation at the foot end of the leading bag 9 is completed such that a sealing seam 9a has been produced there. At the same time, in FIG. 4, the sealing operation for the head end of the trailing bag 10 begins by means of the first sealing regions 13, 14. In FIG. 5, the leading bag 9 has been conveyed further by a conveying device (not shown) and the sealing operation of the head seam at the trailing bag 10 has just been completed. Through the contact between the first sealing regions 13, 14 of the packaging material and the sonotrode and the anvil, a conveying function for the trailing bag 10 is also carried out. Said bag is subsequently filled and conveyed further until the following sonotrode or anvil segments then carry out the foot seam and the tensioning and cutting operation by means of the tensioning and cutting device 5.

Consequently, according to the invention, both the sealing of a head seam and a foot seam and separating of two consecutive bags can be carried out in one operating cycle. The cutting operation, in this case, requires no additional auxiliary power with, for example, pneumatic or hydraulic support and runs completely free of wear.

In addition, it must be noted that by varying the geometry of the cutting edge 6, it is also possible to create different cut contours and, for example, by providing a short additional cutting edge, directed in the direction of rotation, a pull-tab can be inserted into the foot seam of the packaging. In addition, according to the invention, there is no need for vibration decoupling between the components of the ultrasonic welding apparatus and the cutting device as the cutting and tensioning device 5 according to the invention is arranged purely on the anvil 4 and has no contact with the sonotrode 3.

1. An apparatus for welding and separating a packaging material (8), said apparatus comprising
an ultrasonic welding apparatus (2) having a sonotrode (3) with at least one sonotrode segment (3a), and an anvil (4) with at least one anvil segment (4a), and
a combined cutting and tensioning device (5),
wherein the sonotrode (3) is rotatable about a first axis of rotation and wherein the anvil (4) is rotatable about a second axis of rotation,
wherein the cutting and tensioning device (5) is incorporated in the ultrasonic welding apparatus (2), and
wherein the cutting and tensioning device (5) initially tensions the supplied packaging material (8) and then cuts it in the tensioned state by means of a cutting edge (6).

2. The apparatus as claimed in claim 1, characterized in that the cutting edge (6) also tensions the packaging material (9).

3. The apparatus as claimed in claim 1, characterized in that the cutting and tensioning device (5) is located on the anvil (4).

4. The apparatus as claimed in claim 1, characterized in that the sonotrode (3) has a plurality of radially projecting sonotrode segments (3a) and the anvil (4) has a plurality of radially projecting anvil segments (4a).

5. The apparatus as claimed in claim 1, characterized in that the cutting and tensioning device (5) includes an adjusting device (7) in order to adjust the cutting and tensioning device (5) in the radial direction.

6. The apparatus as claimed in claim 1, characterized in that a recess (11) is formed on the sonotrode segment (3a) in order to accommodate the cutting and tensioning device (5) at least partially during the cutting operation.

7. The apparatus as claimed in claim 6, characterized in that the recess (11) is rectangular or triangular or trapezoidal or circular.

8. The apparatus as claimed in claim 5, characterized in that the adjusting device (7) includes a first slanting plane (7a) and a second slanting plane (7b) in order to change a position of the cutting and tensioning device (5) in the radial direction.

9. The apparatus as claimed in claim 1, characterized in that the cutting and tensioning device (5) is arranged so as to be exchangeable.

10. The apparatus as claimed in claim 1, characterized in that the cutting and tensioning device (5) has a straight cutting edge or an undulating cutting edge or a zigzag cutting edge.

11. The apparatus as claimed in claim 1, characterized in that a first sealing region (13, 23) and a second sealing region (14, 24) is realized in each case on the sonotrode segment (3a) and on the anvil segment (4a) and the cutting and tensioning device (5) is arranged on the anvil (4) between the first sealing region (14) and the second sealing region (24).

12. A bag forming, filling and sealing machine, comprising an apparatus for welding and separating as claimed in claim 1.

13. The apparatus as claimed in claim 2, characterized in that the cutting and tensioning device (5) is located on the anvil (4).

14. The apparatus as claimed in claim 13, characterized in that the sonotrode (3) has a plurality of radially projecting sonotrode segments (3a) and the anvil (4) has a plurality of radially projecting anvil segments (4a).

15. The apparatus as claimed in claim 14, characterized in that the cutting and tensioning device (5) includes an adjusting device (7) in order to adjust the cutting and tensioning device (5) in the radial direction.

16. The apparatus as claimed in claim 15, characterized in that a recess (11) is formed on the sonotrode segment (3a) in order to accommodate the cutting and tensioning device (5) at least partially during the cutting operation.

17. The apparatus as claimed in claim 16, characterized in that the recess (11) is rectangular or triangular or trapezoidal or circular.

18. The apparatus as claimed in claim 17, characterized in that the adjusting device (7) includes a first slanting plane (7a) and a second slanting plane (7b) in order to change a position of the cutting and tensioning device (5) in the radial direction.

19. The apparatus as claimed in claim 18, characterized in that the cutting and tensioning device (5) is arranged so as to be exchangeable.

20. The apparatus as claimed in claim 19, characterized in that the cutting and tensioning device (5) has a straight cutting edge or an undulating cutting edge or a zigzag cutting edge.
